(19) United States
(12) Patent Application Publication
(10) Pub. No.: US 2007/0101058 A1
(43) Pub. Date: May 3, 2007

(54) Storage unit configuration

(76) Inventors: Keith R. Kinnan, Cypress, TX (US); Brian J. Corell, Tomball, TX (US); Michael G. Myrah, Houston, TX (US); William Kilcoyne, Tomball, TX (US); Eng K. Lim, Tomball, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/260,051

(22) Filed: Oct. 27, 2005

(51) Int. Cl. G06F 12/16; G06F 9/00

(52) U.S. Cl. 711/114; 713/2

(57) ABSTRACT

A storage unit comprising a plurality of storage devices and a user input/output (“I/O”) device coupled to the plurality of storage devices and adapted for exclusive use with the storage unit. The I/O device is used to create a Redundant Array of Independent Disks (“RAID”) configuration. The plurality of storage devices are configured in accordance with the RAID configuration.

### CROSS-REFERENCE TO RELATED APPLICATIONS

This application contains subject matter which may relate to the commonly-assigned, co-pending application entitled, “Storage Configuration,” application No. 10/999,178 and filed Nov. 29, 2004.

### BACKGROUND

Some storage systems comprising a plurality of storage devices may be operated according to any one of a variety of configurations. Such storage systems are configured prior to their use in accordance with the desired configuration. User friendly mechanisms and procedures for configuring the storage systems are desirable.

### BRIEF DESCRIPTION OF THE DRAWINGS

For a detailed description of exemplary embodiments of the invention, reference will now be made to the accompanying drawings in which:

FIG. 1 shows a system in accordance with various embodiments that permits a user to configure a storage unit by activating a control on the storage unit;

FIG. 2 shows an illustrative control device in the system of FIG. 1, in accordance with embodiments of the invention;

FIG. 3 shows a method in accordance with embodiments of the invention; and

FIGS. 4a-4j show various configuration options that may be displayed on an illustrative control device.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections. The term “system” refers broadly to a collection of two or more components and may be used to refer to an overall system (e.g., a computer system or a network of computers) as well as a subsystem provided as part of a larger system (e.g., a subsystem within an individual computer).

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

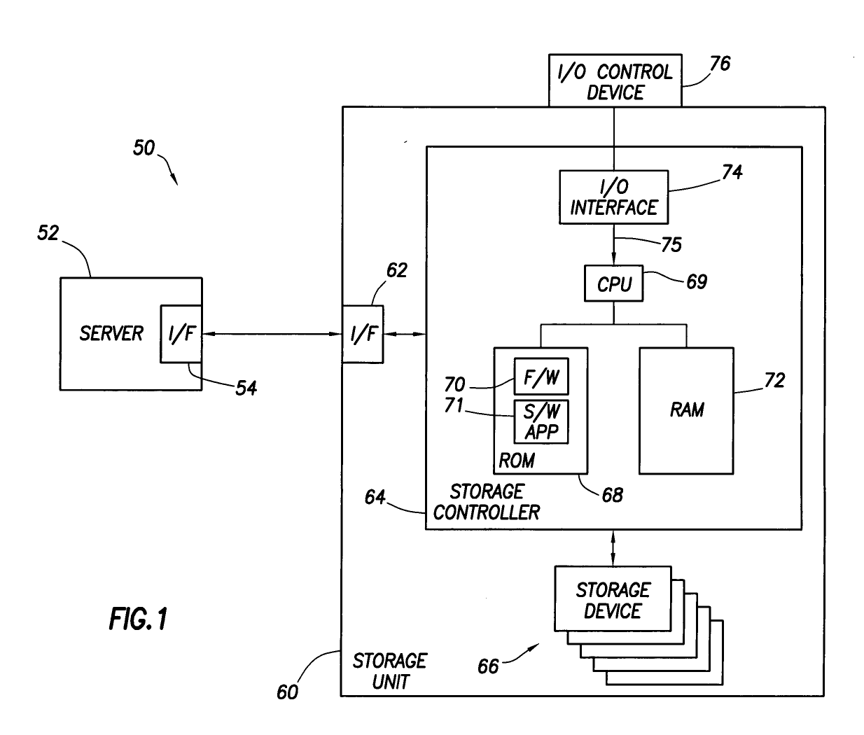

Referring now to FIG. 1, a system 50 is shown in accordance with various embodiments of the invention. As shown, the system 50 comprises a server 52 coupled to a storage unit 60. The server 52 includes an interface 54 and the storage unit 60 includes a corresponding interface 62 to facilitate communication therebetween. The communication link between interfaces 54 and 62 may be implemented in accordance with any suitable communication protocol such as the Small Computer System Interface (“SCSI”) or Fibre channel protocols. The interface 54 may comprise a host bus adapter (“HBA”) in the form of, for example, a network card to facilitate communication between the server 52 and the storage unit 60. The storage unit 60 is used by the server 52 for storage and retrieval of data. As such, the storage unit 60 includes one or more storage devices 66 that may comprise hard disk drives or other suitable types of storage devices. Some embodiments may comprise additional servers communicably coupled to the storage unit 60, where the storage unit 60 can distinguish between the HBAs of the various servers.

In addition to the storage devices 66, the storage unit 60 includes a storage controller 64. The storage controller 64 includes a central processing unit (“CPU”) 69 coupled to a read only memory (“ROM”) 68, to a random access memory (“RAM”) 72, and to an input/output (“I/O”) interface 74. The ROM 68 contains firmware 70 and a software application 71, each of which is executable by the CPU 69. During initialization of the storage unit 60, the firmware 70 and/or the software application 71 may be copied to RAM 72 and thus may be executed by the CPU 69 from the RAM. Either or both of the ROM 68 and RAM 72 comprise a storage medium on which executable code is stored and executed by the CPU 69. The firmware 70 and/or the software application 71 may be stored on other forms of storage as well. The storage controller 64 is capable of receiving service requests from an operating system (e.g., Windows, Linux) running on the server 52.

A user-activated I/O control device 76 is provided on a user-accessible outer surface of the storage unit 60. The storage controller 64 may be fabricated on a printed circuit board. If desired, the I/O control device 76 may be located on a surface of the printed circuit board that is accessible from outside the storage unit 60. Referring briefly to FIG. 2, there is shown a plan view of the I/O control device 76 in accordance with an exemplary embodiment. As shown, the I/O control device 76 comprises a display 78 and a user-activated, directional keypad 80. The display 78 may comprise a graphical display, a text-based display or any other suitable type of display. The display 78 may comprise liquid crystal display (“LCD”) technology, plasma screen technology, light emitting diode (“LED”) technology, or other suitable display technologies. In at least some embodiments, the directional keypad 80 comprises four arrow keys (i.e., “up,” “down,” “left” and “right” arrow keys), an “Enter” key and an “Escape” (“ESC”) key. The arrow keys are used to select from a list of options displayed on the display 78. For example, the arrow keys may be used to move a highlight bar to a desired option. The Enter key is used to select the highlighted option. The Esc key is used to undo a particular selection and, in some embodiments, to return to a previously displayed screen. In other embodiments, the keypad 80 may comprise fewer or more than these keys. In still other embodiments, the I/O device 76 comprises an interactive touch screen that serves as both an input device and an output device, thus eliminating the need for a separate keypad 80. A variety of implementations are possible for the I/O device 76, and the scope of disclosure is not limited to the implementation described above or that shown in FIG. 2.

Referring again to FIG. 1, the l/O interface 74 couples to the I/O control device 76 and detects when one or more of the keys on the keypad 80 are activated by a user. When the I/O interface 74 detects that a user has activated one of the keys, the I/O interface 74 asserts an interrupt signal 75 to the CPU 69. In some embodiments, interrupt processing circuitry may be included in the storage controller 64 to react to the I/O interface's determination that a button has been activated and to assert an interrupt to the CPU.

The storage devices 66 can be configured to operate in any of a plurality of configurations such as any of a variety of Redundant Array of Independent Disks (“RAID”) configurations. Such configurations, also known as “levels,” include RAID0, RAID1+0, RAID1, RAID4, RAID5, RAID5+, RAID6, and other suitable configurations as desired. U.S. Pat. Nos. 6,694,479 and 6,643,822, both of which are incorporated herein by reference, provide various illustrative configurations. Using I/O control device 76, the user can select a predetermined RAID configuration or manually create a RAID configuration on the fly.

In a RAID configuration, a plurality of storage devices (e.g., hard disk drives, also known as physical drives) are provided and configured in a way that provides redundancy. Data is “striped” across multiple storage devices. The multiple storage devices form a “logical drive.” That is, a data set is divided up and stored across a logical drive comprising two or more storage devices. Data may be striped using a variety of stripe sizes (e.g., 16 KB, 64 KB, 256 KB). In a RAID1+0 configuration, storage devices are configured in a “mirrored” implementation in which data may be striped across two storage devices and the same data is also striped across two other storage devices. A RAID4 configuration includes a parity storage device in addition to data storage devices. Information stored on the parity storage device generally is the exclusive-OR (“XOR”) of the data on the data storage devices. In the event of a device failure, data on any of the data or parity storage devices can readily be recovered by computing the exclusive OR of the remaining storage devices. RAID5 is similar to RAID4, but parity information is rotated among the various data drives (i.e., there is no dedicated parity drive). RAID6 is similar to RAID5, except a second set of parity data is written across some or all data drives.

The mechanism by which the storage controller 64 configures the storage devices 66, in accordance with the selected or manually created configuration, can implement any suitable technique, examples of which are described in some or all of the following documents incorporated herein by reference: U.S. Pat. Nos. 6,058,489; 6,418,539; 6,269,453; and 6,061,752. For example, the firmware 70 included in ROM 68 or RAM 72 can be run on the storage controller's CPU 69 to cause the CPU 69 to configure the storage devices 66 in accordance with the user-selected storage device configuration. Such firmware generally performs a function such as creating storage volumes according to parameters such as size, fault tolerance (e.g., RAID), stripe size, sector size, and so on. The firmware also may be used to configure various array controller parameters including cache settings, rebuild priority, expand priority, surface scan delay, access control, etc. as described further below. As such, when a RAID configuration is selected using the keypad 80, an interrupt is asserted to the CPU 69 thereby causing the CPU to determine the nature of the interrupt and execute the firmware to configure the storage devices 66.

A user of the storage unit 60 interacts with the I/O control device 76 to configure the storage devices 66 to a desired RAID configuration such as those described above (or others). The I/O device 76 may be used to configure the storage devices 66 in at least two ways: the device 76 can be used to select from a list of RAID configurations preprogrammed in the storage controller 64 or the device 76 can be used to enable a user to manually create his or her own configuration. Both of these techniques are implemented on the I/O control device 76 by way of either a graphical user interface (“GUI”) or a command line interface (“CLI”). Manually creating a RAID configuration may include selecting various parameters from scratch or modifying (i.e., migrating) an existing configuration.

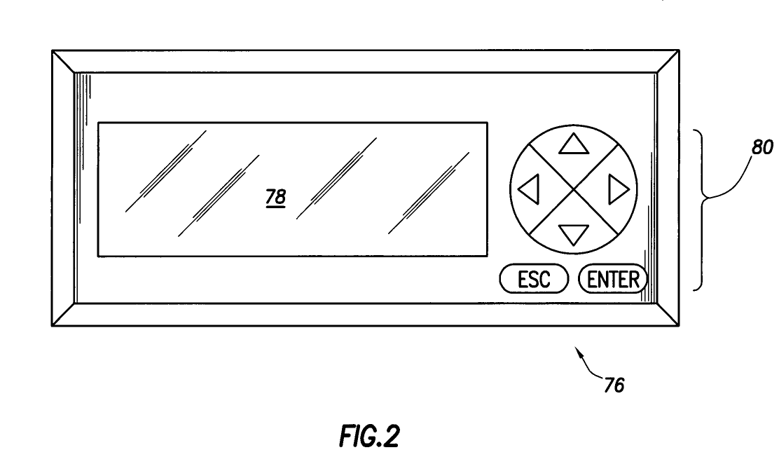

A main menu displayed on the display 78 enables the user to select one of the two options described above: the user may choose to select a pre-programmed configuration, or the user may choose to manually create his or her own configuration. In some embodiments, the main menu is initially displayed when the user boots up the storage unit 60. In other embodiments, the main menu is initially displayed when the user presses a key on the keypad 80, such as the Enter key. Before each of the two options is discussed in turn, reference is made to FIG. 3 which shows a flow diagram of a process 300 that is used to configure the storage devices 66 using the I/O control device 76.

Referring now to FIG. 3, the process 300 begins with booting up the storage unit 60 (block 302). Booting up the storage unit 60, for example, by powering on the storage unit 60, causes the CPU 69 to load the software application 71 from the ROM 68 to the RAM 72. Optionally, as described above, the software application 71 may be loaded when the user presses a key on the keypad 80. In either case, after the software application 71 is loaded to the RAM 72, the CPU 69 executes the software application 71 on the RAM 72. The process 300 further comprises determining the current configuration of the storage devices 66 and, based on the current configuration, generating a list of possible configuration options that a user may select via the I/O control device 76 (block 304). Accordingly, the software application 71 causes the CPU 69 to display one or more of these options on the LCD display 78 (block 306). The software application 71 can cause the CPU 69 to display one option on the display 78 at a time. Alternatively, the software application 71 can cause the CPU 69 to display multiple options on the display 78 at a time. A highlight bar may be used to scroll through the multiple options.

Once the software application 71 has caused the CPU 69 to display one or more configuration options on the display 78, the process 300 comprises monitoring user input received from the keypad 80 (block 308). When the user presses an arrow key on the keypad 80 (block 310), an interrupt signal 75 is asserted by the I/O interface 74 to the CPU 69, which interrupt signal causes the software application 71 to update the options on the display 78, including the highlight bar, accordingly (block 312). For example, assume the display 78 shows five possible options 1-5, with option 1 highlighted as the option currently under consideration by the user. Pressing the “down” arrow key on the keypad 80 may cause the highlight bar to move from option 1 to option 2. In other embodiments, pressing the “right” arrow key on the keypad 80 causes the highlight bar to move from option 1 to option 2. Assuming option 2 is highlighted, pressing the “up” arrow key or the “left” arrow key causes the highlight bar to move from option 2 to option 1. In another example, assume the display 78 shows options 1-5, with option 5 highlighted. Pressing the “down” arrow key causes the display 78 to scroll down such that option 1 “falls off” the top of the display 78 and an option 6 appears at the bottom of the display. In yet other embodiments where only one option is shown on the display at a time, pressing one of the arrow keys on the keypad 80 causes a different option to be displayed. The scope of disclosure is not limited to assigning any particular action to any particular key on the keypad 80. After an arrow key is pressed (block 310), the process 300 resumes at block 306.

When presented with options on the display 78 at block 306, if the user presses the “Enter” key on the keypad 80 (block 314), then the option that is currently highlighted (in embodiments where multiple options are displayed at a time) or the option that is shown on the display 78 (in embodiments where only one option is displayed at a time) is selected. When the Enter key is pressed, the process 300 comprises asserting an interrupt signal 75 to the CPU 69 (block 316), which interrupt signal causes the CPU 69 to determine whether the item selected requires the user to make further selections (block 318). Execution of the software application 71 reveals whether additional data is required by the application 71 to configure the storage devices 66. For example, a subroutine in the application 71 may be dedicated to gathering input data from the user. After making a selection, a portion of the subroutine may have been executed, but additional portions of the subroutine may remain unexecuted, thus indicating to the CPU 69 that additional selections need to be made by the user.

As is described in further detail below, in case an item is selected that requires no further user selections, the process 300 comprises sending one or more commands to the firmware 70 from the software application 71 (block 320). The firmware 70 performs the received command(s), thereby updating the configuration of the storage devices 66 using the new configuration selected via the I/O device 76 (block 322). The software application 71 then displays the storage device 66 configuration status on the display 78. The user presses Enter to confirm the status of the storage devices 66 (block 324), and the process 300 resumes at block 304.

However, in case further selections are required (block 318), then another iteration of the process 300 is performed so that the user can make additional selections. Before another iteration of the process is performed, however, the selections that the user has made thus far are stored in the memory (e.g., RAM 72) so that the selections are not lost (block 326). Selections may be stored to the memory in this fashion with each iteration of the process 300 that is performed. Additional iterations of the process 300 are performed until no further selections are required. At this point, all user selections stored in memory are collectively used to configure the storage devices 66 using the steps in blocks 320-324. If, instead of pressing the Enter key or an arrow key, the user presses the Esc key (block 328), the process 300 comprises clearing any selections stored in memory (block 330) and control of the process 300 returns to block 304.

If the user chooses on the main menu to select a preprogrammed RAID configuration, the user is prompted to select from a list of preprogrammed RAID configurations. For example, the display 78 may prompt the user to select from a list comprising RAID6, RAID5, RAID1+0, and RAID0, although the scope of disclosure is not limited as such. If the user selects a preprogrammed RAID configuration using the keypad 80, the display 78 presents the user with the option of selecting a spare (i.e., backup) drive. A spare drive comprises a storage drive 66 (e.g., physical drive) that is already included in the storage unit 60 but has not yet been assigned to any particular RAID configuration or logical drive. The spare drive is added to the RAID configuration selected in block 350 and is used as a replacement (i.e., backup) drive in case a drive in the RAID array fails or becomes corrupted. In particular, if a physical drive in the RAID array fails or is corrupted, the spare drive is used in its place, and the data that was previously stored on the failed/corrupted drive is repopulated on the spare drive. After the user is finished making the appropriate selections, the display 78 returns to the main menu.

On the main menu, if the user chooses instead to create his or her own configuration, then the user is presented with another menu that displays at least two different ways for the user to create a configuration: the device 76 can guide the user through the process of creating a new or migrating an existing configuration, or the device 76 can be used to assemble a command line interface (“CLI”) command to create a new or migrate an existing configuration. Each of these two options is now discussed in turn.

To have the storage unit 60 guide the user through the process of generating a new RAID configuration or migrating a RAID configuration, a series of options as described below is presented on the display 78. Specifically, the display 78 prompts the user with a variety of possible actions, including:
Create Array
Expand Array
Delete Array
Add Spare to Array
Remove Spare from Array
Create Logical Drive
Migrate Logical Drive
Accelerate Logical Drive Array
Extend Logical Drive
Delete Logical Drive
Controller Settings
Selective Storage Presentation
Show Current Configuration
Clear Current Configuration
   As previously mentioned, these options may be presented one at a time on the display 78 or, in some embodiments, several options may be displayed at a time. In embodiments where the options are displayed one at a time, a user locates the desired option using the arrow keys on the keypad 80 and presses the Enter key when the desired option appears on the display 78. In embodiments where multiple options are displayed at a time, the user uses the arrow keys to highlight the desired option and presses the Enter key when the desired option is highlighted. Each of these options is now discussed in turn.

The user may choose the “Create Array” option to generate a new RAID configuration. When the “Create Array” option is selected, the display 78 prompts the user to make further selections:

Create Array

Add physical drive
Done
   Thus, the user can select either “Add physical drive” to add a physical drive already present in the storage unit 60 or the user can select “Done” to exit the “Create Array” subcategory and to return to the previous list of options. The user also may press the Esc key to return to the previous list of options. “Adding” a physical drive comprises assigning a physical drive, already present in the unit 60, to the new array being created. If the user selects the “Add physical drive” option, the user is prompted to select from a list of physical drives:
   Create Array-Add Physical Drive
Physical Drive 1
Physical Drive 2
Physical Drive 3
Physical Drive 4
Physical Drive 5
   Thus, the user can select from a variety of physical drives already present in the storage unit 60 to add to a new array. When the user has finished selecting the appropriate physical drive, the display is returned to the “Create Array” subcategory shown above, where the user may either add another physical drive to the array or may select the “Done” option to return to the previous list of options.

The user may choose the “Expand Array” option described above to expand an existing array by adding physical drives to the array. When the user selects the “Expand Array” option, the user is prompted with further selections:

Expand Array

Add Physical Drive
Done
   As described in context of the “Create Array” subcategory, the user may choose to either add a physical drive or to exit the “Expand Array” subcategory by selecting “Done.” If the user selects the “Add Physical Drive” option, the user is prompted to select from a list of physical drives as under the “Create Array” subcategory. If the user selects the “Done” option, the display 78 returns to the previous list of options.

The user may choose the “Delete Array” subcategory to delete an entire array. Upon choosing the “Delete Array” subcategory, the user is prompted to select an array for deletion, and is further prompted for confirmation of the deletion request in order to avoid an unintentional deletion of an array. Some options available under the “Delete Array” subcategory are as follows:

Delete Array

Select Array
Done
   If the user selects the “Done” option or the Esc key, the display 78 is returned to the previous list of options. If the user selects the “Select Array” option, then the user is prompted to select one or more arrays from a list of arrays:
   Delete Array-Select Array
Array A
Array B
Array C
   Once the user selects an array for deletion, the user is prompted to confirm the deletion request. For example, if the user chooses to delete Array A, the user is prompted as follows:
   Delete Array-Select Array-Array A
Delete Array A?
Yes
No
   If the user selects “Yes,” then the Array A is deleted. If the user selects “No,” the Array A is not deleted and the display 78 is returned to the previous screen. As mentioned above, the Esc key may be used at virtually any time to return to a previous screen.

The user may choose the “Add Spare to Array” subcategory from the list above in order to add spare drives to an existing array. Upon selecting the “Add Spare to Array” subcategory, the user may be prompted as follows:

Add Spare to Array

Select Array
Done
   The user may select “Done” to exit from the “Add Spare to Array” subcategory. Alternatively, the user may select “Select Array” to choose an array to which a spare drive is to be added. Upon choosing the “Select Array” option, the user may be prompted as follows:
   Add Spare to Array-Select Array
Array A
Array B
Array C
. . .
   Upon selecting an array, the user then is prompted to select a spare drive to add to the selected array. For example, if the user selects “Array A,” then the user may be prompted as follows:
   Add Spare to Array-Select Array-Array A
Physical Drive 1
Physical Drive 2
Physical Drive 3
. . .
   The user may select one of these spare drives to add to Array A. Upon selecting a drive, the user is returned to the previous list of options.

Likewise, the user may choose the “Remove Spare from Array” option to remove a spare drive from an existing array. The process of selecting an array and then selecting a spare for removal is similar to that described above in context of the “Add Spare to Array” option and thus is not repeated here.

The user may select the “Create Logical Drive” option to create a logical drive by selecting a RAID configuration, a stripe size, a sector number and a logical drive size. More specifically, upon selecting the “Create Logical Drive” option, the user is prompted with the following options:

Create Logical Drive

Set RAID
Set Stripe Size
Set Sectors
Set Size
Done
. . .
   Upon selecting the “Set RAID” option, the user is further prompted to select a RAID configuration for the logical drive (i.e., grouping of physical drives) being created:
   Create Logical Drive-Set RAID
RAID6
RAID5
RAID1+0
RAID0
. . .
   Although the selected RAID configuration comprises default settings for stripe size, sector number, and logical drive size, these components of the RAID configuration may be modified from their default values. Accordingly, upon selecting a RAID configuration, the user is returned to the previous list of options, where the user can choose to set a stripe size, set a sector, set size of the logical drive, or exit by selecting the “Done” option. If the user selects the “stripe size” option, the user is prompted to select a stripe size for the logical drive:
   Create Logical Drive-Set Stripe Size
1 16 KB
32 KB
64 KB
128 KB
256 KB
. . .
   The scope of disclosure is not limited to selecting one of these stripe sizes, and other stripe sizes may be offered on the display 78. In some embodiments, the user may enter, via the keypad 80, a desired stripe size. For example, the image of a numerical keypad may be displayed on the display 78, and the user may select various numbers on the numerical keypad image using the arrow keys on the keypad 80. By selecting numbers on the image of the numerical keypad, the user indicates to the CPU 69 the desired stripe size. The numerical keypad image technique (or any other suitable technique) also may be used to manually enter desired parameters for each of the categories discussed below. Furthermore, the scope of disclosure is not limited to the options shown in each of the categories below.

In addition to setting the stripe size, the user also may set a sector number:

Create Logical Drive-Set a Sector

32
63
. . .
   The sector number indicates the number of sectors included per track in each physical drive of the logical drive. The user also may select a size of the logical drive:
   Create Logical Drive-Set Size
Maximum possible
2000 MB
1900 MB
1800 MB
. . .
   The user may select any or all of these options and, once the appropriate selections have been made, the user may select “Done” or press the Esc key to return to the previous list of options.

The user may select the “Migrate Logical Drive” option to migrate (i.e., edit or modify) an existing logical drive. Upon selecting the “Migrate Logical Drive” option, the user is prompted as follows:

Migrate Logical Drive

Set RAID
Set Stripe Size
Done
   If the user selects the “Set RAID” option, the display 78 prompts the user to select one of the RAID configurations (e.g., RAID6, RAID5, RAID1+0, RAID0) described above. If the user selects the “Set Stripe Size” option, the display 78 prompts the user to select one of the Stripe Size options (e.g., 16 KB, 32 KB) as described above. Selecting the “Done” option returns the user to the previous list of options.

The user may select the “Accelerate Logical Drive Array” option in order to enhance performance of a specific logical drive by providing the drive with a cache. By providing a cache to a drive selected for acceleration, data access from the drive is performed more quickly than from a drive without a cache, thus improving performance. When this option is selected, the display 78 prompts the user:

Accelerate Logical Drive Array

Select Logical Drive
Done
   Selecting the “Select Logical Drive” option causes the display 78 to show the logical drives available for acceleration:
   Accelerate Logical Drive Array-Select Logical Drive
1
2
3
. . .
   Upon selecting a logical drive, the user is further prompted to enable or disable acceleration for the selected logical drive:
   Accelerate Logical Drive Array-Select Array Accelerator State
Enable
Disable
   Once the user selects either the “Enable” or “Disable” state, the selected logical drive is provided with a cache, and the user is returned to the “Accelerate Logical
   Drive Array” subcategory, which subcategory the user may exit by selecting the “Done” option or pressing the Esc key.

The user may extend (i.e., increase the size of) an existing logical drive by selecting the “Extend Logical Drive” option. Upon selecting this option, the user is prompted to select a specific logical drive or to exit the subcategory:

Extend Logical Drive

Select Logical Drive
Done
   Upon choosing the “Select Logical Drive” option, the user is further prompted with a list of possible logical drives to choose from:
   Extend Logical Drive-Select Logical Drive
1
2
3
. . .
   The user may select one of the logical drives for expansion by, for instance, highlighting the desired logical drive and pressing the Enter key. Once the desired logical drive is selected, the user is prompted to select an expansion size:
   Extend Logical Drive-Select Logical Drive-Select Expansion Size
Maximum possible
2000 MB
1900 MB
. . .
   Once the user selects the desired expansion size, the selected logical drive is expanded to the selected expansion size. The display 78 subsequently returns to the “Extend Logical Drive” subcategory, whereupon the user may press the Esc key or select the “Done” option to exit the subcategory.

The user also has the option of deleting an existing logical drive by selecting the “Delete Logical Drive” option. When this option is selected, the user is prompted as follows:

Delete Logical Drive

Select Logical Drive
Done
   If the user chooses the “Select Logical Drive” option, the user is prompted to choose a specific logical drive for deletion:
   Delete Logical Drive-Select Logical Drive
1
2
3
. . .
   Upon selecting the desired logical drive, the user is prompted for confirmation (e.g., a Yes/No prompt) of the deletion request to avoid any unintentional deletions. If the user selects “Yes,” then the selected logical drive is deleted and the user is returned to the “Delete Logical Drive” subcategory, which may be exited by pressing the Esc key or selecting the “Done” option. If the user selects “No,” then the user is returned to the “Delete Logical Drive” subcategory without deleting the selected logical drive.

The user may select the “Controller Settings” option to modify existing settings for the storage controller 64. Upon selecting this option, the user is prompted with the following options:

Controller Settings

Set Rebuild Priority
Set Expand Priority
Set Cache Ratio
Set Surface Scan Delay
Done
   When a failed or corrupted physical drive is replaced with a new drive, the rebuild priority indicates the level of priority that the rebuilding of data on the new drive has over handling requests from the operating system running on the server 52. If the user selects the “Set Rebuild Priority” option, the user is prompted with the following options:
   Controller Settings-Set Rebuild Priority
High
Medium
Low
   Selecting the “high” rebuild priority level indicates that the rebuilding of data on the new drive is of grater priority that handling requests from the server operating system. Similarly, selecting the “low” rebuild priority level indicates that the rebuilding of data on the new drive is of lesser priority than handling requests from the sever operating system. When an additional drive is added to an array, the expand priority indicates the level of priority that the expansion of the array's capacity has over handling requests from the operating system running on the server 52. If the user selects the “Set Expand Priority” option, the user is prompted with the following options:
   Controller Settings-Set Expand Priority
High
Medium
Low
   Selecting a “high” expand priority level indicates that the expansion of the array's capacity has greater priority over handling requests from the operating system running on the server 52. Selecting the “low” priority level indicates that the expansion of the array's capacity has lesser priority over handling requests from the operating system running on the server 52. Although not specifically shown in FIG. 1, the controller 64 comprises an I/O cache. The cache ratio indicates the percentage of the cache that is to be dedicated to read instructions and the percentage of the cache that is to be dedicated to write instructions. If the user selects the “Set Cache Ratio” option, the user is prompted with the following options:
   Controller Settings-Set Cache Ratio
100 % Read/0% Write
75% Read/25% Write
50% Read/50% Write
25% Read/75% Write
. . .
   If the user selects the “Set Surface Scan Delay” option, the user is prompted with the following options:
   Set Surface Scan Delay
25 ms
20 ms
15 ms
. . .
   The surface scan delay indicates the length of time after an I/O instruction is executed before which parity writing is initialized on one of the storage devices 66. For example, if the 20 ms option is selected, then when new information is written to a drive, parity bits for the new information are not written until 20 ms have elapsed. If the user selects the “Done” option, the user is returned to the previous list of options.

The user also may select the “Selective Storage Presentation” (“SSP”) option. SSP is primarily used in applications where the storage unit 60 is coupled to more than one server. In some such storage units 60, it may be desirable to restrict access of certain logical drives to certain servers, so that each server can access only designated logical drives in the storage unit 60. Specifically, selecting this option produces the following list of options:

Selective Storage Presentation

Set Access Control
Set Host Mode
Done
   If the user selects the “Set Access Control” option, the user is prompted to select a logical drive:
   Selective Storage Presentation-Set Access Control
Select Logical Drive
Done
   If the user chooses the “Select Logical Drive” option, the user is prompted to select from a list of logical drives:
   Selective Storage Presentation-Set Access Control-Select Logical Drive
1
2
3
4
. . .
   After selecting a desired logical drive, the user is further prompted to add or remove host bus adapter (“HBA”) access. As previously mentioned, each server interface 54 comprises an HBA that is different from the HBA of the other server interfaces. The HBA comprises an I/O card or network card that enables the server to communicate with the storage unit 60. By adding or removing HBA access for a particular logical drive, the servers which can or cannot access the logical drive are designated. Any number of logical drives may be designated for use by a particular server.
   Selective Storage Presentation-Set Access Control
Add HBA Access
Remove HBA Access
Done
   If the user chooses to “Add HBA Access,” the user is presented with the following options:
   Selective Storage Presentation-Set Access Control-Add HBA Access
WWN 123123123
WWN 123123125
. . .
   where WWN123123123 and WWN123123125 are codes used to represent HBAs for specific server interfaces. Thus, for example, if the user previously selected logical drive “2” and then selected WWN123123123, then the server comprising HBA WWN123123123 would have access to logical drive 2, whereas other servers may not. This process may be repeated to provide other servers with access to logical drive 2. If the user chooses to “Remove HBA Access,” the user is presented with the following options:
   Selective Storage Presentation-Set Access Control-Remove HBA Access
WWN 123123123
WWN 123123125
. . .
   Under either the “Add HBA Access” or “Remove HBA Access” options, when the desired selections have been made, the user is returned to the “Selective Storage Presentation” subcategory, whereupon the user may exit the subcategory by pressing the Esc key or selecting the “Done” option. The user also may select the “Set Host Mode” option. More specifically, each server (i.e., comprising an HBA) communicates with the storage unit in a different operating system environment (e.g., Windows, Linux). This operating system environment may be changed as desired by accessing the “Set Host Mode” option, whereupon the user is first prompted to select a specific HBA:
   Selective Storage Presentation-Set Host Mode-Select HBA
WWN 123123123
WWN 123123125
. . .
   After the desired HBA is selected, the user is further prompted to select the desired host mode for that specific HBA:
   Selective Storage Presentation-Set Host Mode-Select Desired Host Mode
Windows
Linux
. . .

The user also may select the “Show Configuration” option, in which case the display 78 shows the current configuration of the storage devices 66. This information is relayed to the display by the software application 71 being executed by the CPU 69. The configuration may be displayed on the display 78 in graphical or text format. Finally, the user also may select the “Clear Configuration” option in order to clear the current RAID configuration for a particular logical drive. The user may be prompted for a confirmation to clear the configuration.

As previously mentioned, if the user chooses to create his or her own configuration, then the I/O device 76 may be used to configure the storage devices 66 in at least two ways: the device 76 can guide a user through the process of creating a new or migrating an existing RAID configuration, or the device 76 can be used to assemble a command line interface (“CLI”) command to create a new or migrate an existing RAID configuration. Unlike a graphical user interface, a CLI comprises a textual, line-based interface where commands are specified in response to a prompt. Assuming proper command syntax is used, the CPU providing the CLI performs the function indicated by the CLI command.

In at least some embodiments, the CLI command assembled by the user comprises three components, although the scope of disclosure is not limited as such. Specifically, the device 76 is used to manually assemble the CLI command by selecting a target (e.g., the controller 64, an array, a logical drive, a physical drive), an action to perform on the target (e.g., create, modify, show, delete, add, remove), and command parameters that are associated with the action. The user selects the target, action and parameters from lists that are provided to the user via the display 78. As the user selects each component of the CLI command, the software application 71 causes the CPU 69 to receive the user's selection and to decode the user's selection into the appropriate CLI syntax. The CPU 69 decodes the user's selection using, for instance, a pre-programmed data structure stored on the controller 64 that correlates possible user selections with corresponding CLI syntax. In an exemplary embodiment, the display 78 shows the appropriate CLI command syntax as the command is being assembled by the user. In other embodiments, the CLI command is shown in a non-syntax (i.e., user-friendly) form as it is assembled by the user. After the CLI command is assembled, it is sent from the software application 71 to the firmware 70. The firmware 70 executes the command and configures the storage devices 66 as instructed by the command.

In particular, if the user selects the option to assemble a CLI command, the display 78 first prompts the user to select a target:

Select Target

Controller
Array A
Array B
Array C
. . .
Logical Drive 1
Logical Drive 2
Logical Drive 3
. . .
Physical Drive 0:0
Physical Drive 0:1
. . .
   The above list of target options is not exhaustive. Using the keypad 80, the user selects the desired target and presses the Enter key. For example, if the user wishes to perform some action on the logical drive 1, then the user may select the “Logical Drive 1” option and press the Enter key. If the user wishes to create a logical drive, then the user may select the “controller” option and press the Enter key.

Upon selecting a target for the CLI command being assembled, the user is prompted to select an action to perform on the selected target (some actions may not be available, depending on the target selected):

Select Action

Create
Modify
Show
Delete
Add
Remove
Done
   The user may select a desired action from the list above using the keypad 80. For example, the user may select the “Create” option. Having selected a desired target and a desired action for the target, the user is further prompted as follows:
   Create
Set Parameter
Done
   If the user selects the “Set Parameter” option, the user is further prompted to specify a parameter for the CLI command being assembled:
   Create-Set Parameter
Drives
RAID
Size
Stripe Size
Sectors
Array Accelerator
   If the user selects the “Drives” option, the user is prompted to select a specific drive(s):
   Create-Set Parameter-Drives
All
0:0
0:1
1:1
. . .
   If the user selects the “RAID” option, the user is prompted to select a specific RAID configuration:
   Create-Set Parameter-RAID
RAID6
RAID5
RAID1
RAID0
. . .
   If the user selects the “Size” option, the user is prompted to select a specific size of the drive (e.g., logical drive, physical drive) being created:
   Create-Set Parameter-Size
Maximum possible
2000 MB
1900 MB
. . .
   If the user is creating or modifying a logical drive, a stripe size can be selected. If the user selects the “Stripe Size” option, the user is prompted to select a specific stripe size:
   Create-Set Parameter-Stripe Size
8 KB
16 KB
32 KB
64 KB
128 KB
256 KB
. . .
   If the user selects the “Sectors” option, the user is prompted to select a specific number of sectors per track on the physical drive or, in case a logical drive is being created, the number of sectors per track on each physical drive in the logical drive. Accordingly, the user is prompted as follows:
   Create-Set Parameter-Sector
32
63
. . .
   If the user selects the “Array Accelerator” option, the user is prompted to either enable or disable the accelerator:
   Create-Set Parameter-Array Accelerator
Enable
Disable
   The user may select the “Done” option when finished. Selecting the “Done” option returns the user to the main menu and causes the assembled command to be sent to the firmware 70 for processing.

Another action that the user may select is the “Modify” action. If the user selects the “Modify” action, the user is prompted to specify parameters associated with the action. An exemplary list of possible parameters are specified below in outline format for brevity and because most of the parameters are similar to options described above. The actual parameters may be presented to the user on the display 78 in any suitable format.

Modify-Set Parameter

LED
   On
   Off
Size
   Maximum possible
   02000 MB
   01900 MB
   . . .
Stripe Size
   8 KB
   16 KB
   32 KB
   64 KB
   128 KB
   256 KB
   . . .
SSP
   On
   Off
Mask
   All
   1231235
   1231237
Unmask
   All
   1231235
   1231237
. . .
Sectors
   32
   63
. . .
Array Accelerator
   Enable
   Disable
Rebuild Priority
   High
   Medium
   Low
Expand Priority
   High
   Medium
   Low
Cache Ratio
   100%/0%
   75%/25%
   50%/50%
   25%/75%
Surface Scan Delay
   25 ms
   20 ms
   15 ms
. . .
Done

The user also may select the “Show” or “Delete” options. However, these options do not require a parameter and thus once a target and one of these actions has been selected, the CLI command is complete and is sent to the firmware 70 for processing.

The user may further select the “Add” option. Like the “Modify” option above, the various options available under “Add” are reproduced in outline format below for brevity and because similar options have already been described above:

Add-Set Parameter

Drives
   All
   0:0
   0:1
   1:1
Spares
   All
   0:0
   0:1
   1:1
. . .
Done

The user also may select the “Remove” option as an action. The outline for the “Remove” option is as follows:

Remove-Set Parameters

Spares
   All
   0:0
   0:1
   1:1
Done

The user is able to make all necessary selections using only the I/O device 76. Specifically, whether the user chooses to select from a pre-programmed configuration or to create a new configuration, the user is able to do so using only the I/O device 76 and without having to use a QWERTY keyboard, the server 52, or any other device.

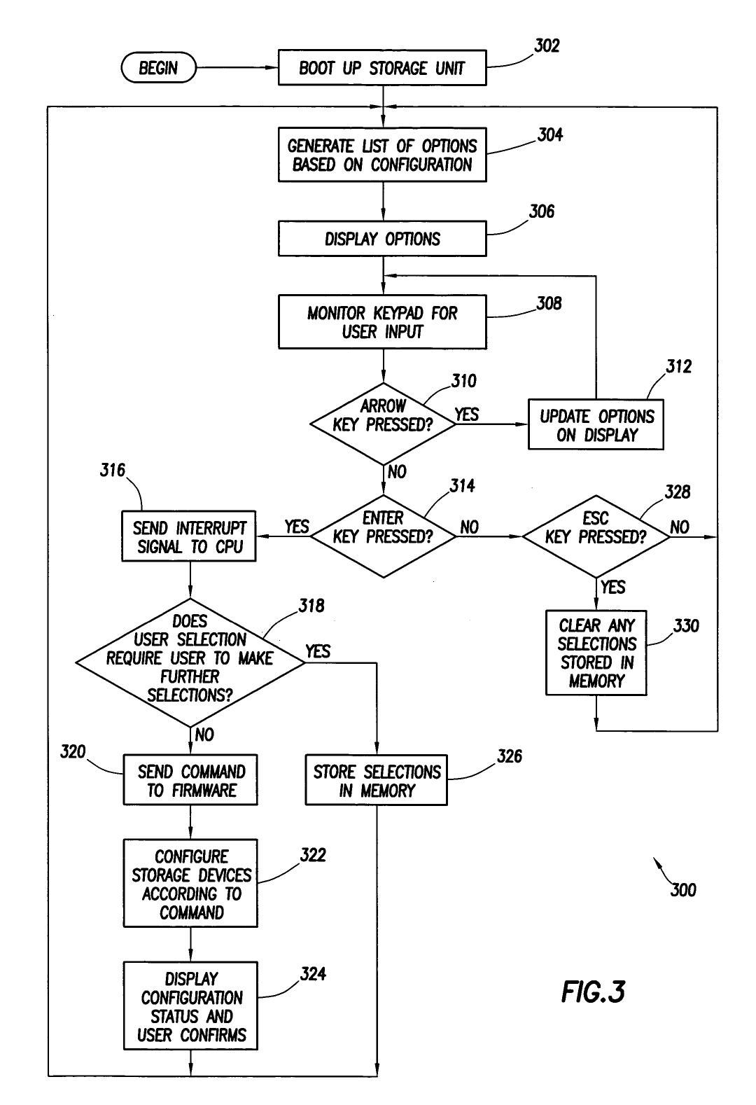

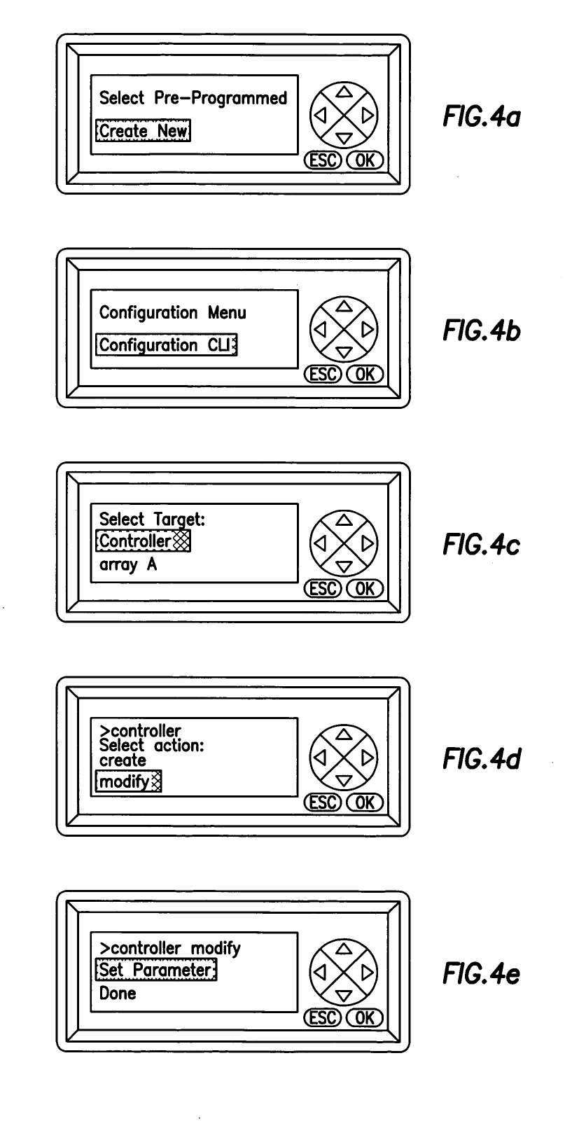

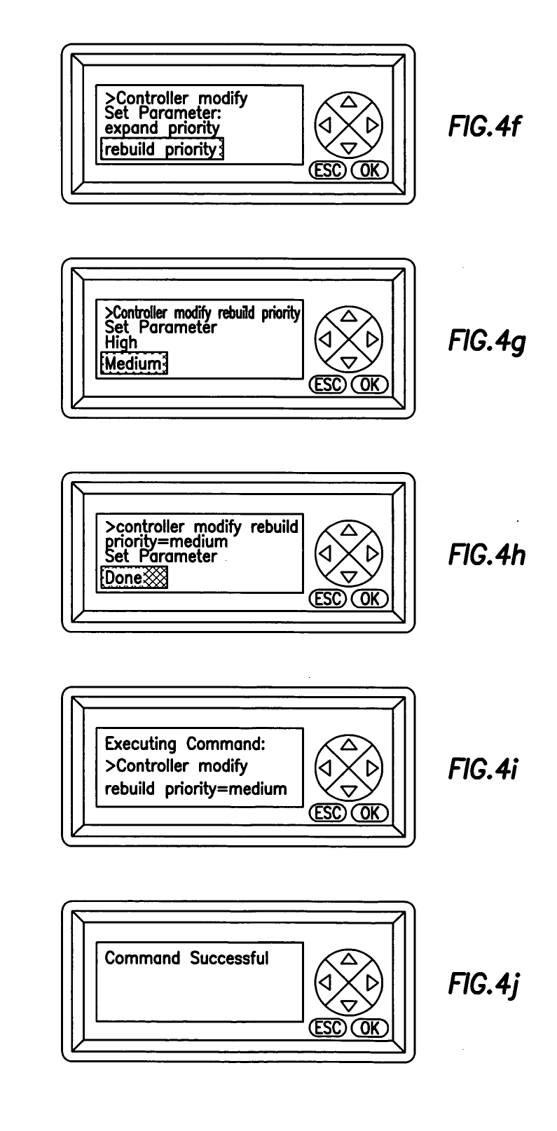

FIGS. 4a-4j show a series of images of an illustrative I/O control device 76 as it is used to assemble a CLI command. Referring to FIG. 4a, the main menu is shown where the user has the option of selecting from a plurality of preprogrammed RAID configurations (shown as “Select Pre-programmed”) or creating his or her own configuration (shown as “Create New”). In FIG. 4a, the arrow keys of the keypad 80 have been used to highlight the “Create New” option. The user may press the Enter key to select the “Create New” option.

Once the Enter key is pressed and the “Create New” option is selected, the user is further prompted to select which method is desired to create a new configuration. Specifically, as shown in FIG. 4b and as previously discussed, the user may either have the controller 64 guide the user in assembling a new configuration (shown as “Configuration Menu”), or the user may manually assemble a CLI command (shown as “Configuration CLI”) which, when performed, configures the storage devices 66 as specified by the command. In FIG. 4b, the arrow keys of the keypad 80 have been used to highlight the “Configuration CLI” option. The user may press the Enter key to select the “Configuration CLI” option.

Once the Enter key is pressed and the “Configuration CLI” option is selected, the user is prompted to select a target, as described above and as shown in FIG. 4c. Although only two options, “Controller” and “Array A” are shown on the display 78, additional options may be viewed by scrolling up or down using the arrow keys. In this example, the “Controller” is selected as the target. Accordingly, the “Controller” is highlighted and the Enter key is pressed.

Once the “Controller” has been selected, the CPU 69 retrieves the appropriate CLI syntax corresponding to the “Controller” selection and begins to assemble the CLI command using the proper syntax. In some embodiments, such as that shown in FIG. 4d, the CLI command is shown at the prompt “>” as it is assembled by the user. As mentioned above, the CLI command may be shown at the prompt in proper syntax form or in any other suitable form.

Also as shown in FIG. 4d, the user is prompted to select an action to perform on the controller, as described above. FIG. 4d only shows the “Create” and “Modify” options on the display 78, but additional options may be viewed by scrolling with the arrow keys. In the example shown in FIG. 4d, the “Modify” action is selected by highlighting “Modify” and pressing the Enter key.

As shown in FIG. 4e, after a target has been selected and an action has been specified for the target, the display 78 shows the CLI command at the “>” prompt as it has been assembled thus far. Also as shown in FIG. 4e, the user is given the choice of selecting a parameter or finishing the command without adding a parameter. In this example, a parameter is to be added, so the “Parameter” option is highlighted and the Enter key is pressed.

As described above and as shown in FIG. 4f, multiple parameters may be entered. In this example, the “Rebuild Priority” option is selected. As shown in FIG. 4g, the user is prompted to select a rebuild priority level. The user selects the “Medium” level by highlighting the “Medium” option and pressing the Enter key. FIG. 4h shows the CLI command as it has been assembled thus far. Also as shown in FIG. 4h, the user is prompted to either select another parameter or to finish the CLI command. FIG. 4h shows the “Done” option being selected, so the CLI command is complete and no other parameters are added. Because the CLI command is complete, the command is passed from the software application 71 to the firmware 70, which firmware 70 configures the controller 64 based on the command's target, action and parameter.

In some embodiments, some or all of the storage unit 60 is automatically powered off by the CPU 69 so that the storage devices 66 may be configured as indicated by the user. After the storage devices 66 are configured, the CPU 69 automatically powers the storage unit back on. In other embodiments, the configuration may be changed while the system is operational, first quiescing the storage unit 60. For example, all storage device accesses may be buffered. While the storage devices 66 are quiesced, the configuration may be changed as explained above. In other embodiments, the configuration can be changed without quiescing accesses to the storage devices 66. U.S. Pat. No. 6,058,489, incorporated herein by reference, illustrates at least one technique for changing a RAID configuration while still permitting a storage system to be operational.

The status of the CLI command as it is executed is shown in the display 78 as in FIG. 4i. When the command executed is complete, the display 78 shows whether the command was successfully executed, as in FIG. 4j.

When the user enables power to the storage unit for the first time, the display 78 may be made to indicate to the user a suggested storage device configuration. The user can elect to implement the suggested configuration by pressing the Enter key on the keypad 80. Alternatively, the user can select a different configuration provided on the display 78 by using the keypad 80. The configuration suggestion may be programmed during manufacturing of the storage unit and may be specific to the purchaser. For example, the storage unit manufacturer may cause the storage unit to suggest one configuration for one purchaser and a different configuration for another customer. The different configurations may be determined from knowledge of the purchasers' intended applications. In some embodiments, the storage unit 60 configuration may be implemented even in the absence of an affirmative choice by a user. That is, a default configuration will be implemented for the storage devices if the user does not actively make a choice. The default configuration may be implemented if user input via the keypad 80 is not detected within a predetermined amount of time following powering up of the storage unit 60 for the first time.

To safeguard against inadvertently pressing one of the keys on the keypad 80, the I/O interface 74 may be configured to only cause the interrupt 75 to be asserted if a key is activated for more than a threshold amount of time (for example, 2 seconds). Further still, mechanical switch guards may be included that prevent a key from being pressed absent the guards being released and moved out of the way. In some embodiments, the I/O interface 74 may be protected by an enclosure that is secured using a physical lock and key. In yet other embodiments, the software application 71 (or the firmware 70) may be configured to prompt a user for a password or PIN code upon boot up, thus protecting the storage unit 60 from being configured by unauthorized users.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A storage unit, comprising:
a plurality of storage devices; and
a user input/output (“I/O”) device coupled to the plurality of storage devices and adapted for exclusive use with said storage unit;
wherein the I/O device is used to create a Redundant Array of Independent Disks (“RAID”) configuration;
wherein the plurality of storage devices are configured in accordance with said RAID configuration.

2. The storage unit of claim 1 further comprising a storage controller coupled to the storage devices and adapted to configure the storage devices in accordance with said RAID configuration.

3. The storage unit of claim 1, wherein said RAID configuration is created or migrated by executing a command assembled using the I/O device.

4. The storage unit of claim 3, wherein the command indicates a target device, an operation intended for said target device, and a parameter to be used in association with the operation on said target device.

5. The storage unit of claim 1, wherein the I/O device is provided on an outer surface of the storage unit.

6. The storage unit of claim 1, wherein the I/O device comprises a display and a keypad.

7. The storage unit of claim 6, wherein the display is selected from the group consisting of a liquid crystal display (“LCD”), a plasma screen, a light emitting diode (“LED”) display and a touch-screen.

8. The storage unit of claim 6, wherein the keypad comprises multiple directional keys and a confirmation key.

9. The storage unit of claim 1, wherein the I/O device comprises a touch-screen display.

10. The storage unit of claim 1, wherein the storage devices are configured according to a plurality of options displayed and selected using the I/O device.

11. The storage unit of claim 1 further comprising a CPU and code executable by said CPU, said code adapted to be executed upon a user activating the I/O device and said code adapted to cause said CPU to configure the storage devices.

12. The storage unit of claim 1, wherein the I/O device is used to migrate a storage device configuration.

13. The storage unit of claim 1, wherein the I/O device displays a menu comprising a plurality of options, and wherein the I/O device comprises a keypad that is used to scroll through said plurality of options.

14. A system, comprising:
a storage unit comprising a plurality of storage devices, a controller, a keypad and a display;
wherein the controller is adapted to configure the plurality of storage devices in accordance with a pre-programmed RAID configuration selected using the keypad and display;
wherein the controller is adapted to configure the plurality of storage devices in accordance with a different RAID configuration created using the keypad and display.

15. The system of claim 14, wherein the keypad and display are used to assemble a configuration command that corresponds to said different RAID configuration.

16. The system of claim 15, wherein the controller configures the plurality of storage devices in accordance with said different RAID configuration by executing said configuration command.

17. The system of claim 15, wherein the configuration command indicates a target device, an operation intended for said target device, and a parameter to be used in association with said operation on the target device.

18. The system of claim 14, wherein the keypad and display are provided on an outer surface of the storage unit.

19. The system of claim 14, wherein said keypad comprises a directional keypad.

20. The system of claim 14 further comprising a computer coupled to said storage unit, wherein the keypad and display are used to designate one or more storage devices to which the computer has access.

21. A method implemented in a storage unit, comprising:
receiving a signal from an input/output (“I/O”) device directly connected to the storage unit, said signal indicative of a configuration command assembled using the I/O device for implementation in said storage unit; and
configuring said storage unit in accordance with said configuration command.

22. The method of claim 21, wherein configuring said storage unit in accordance with said configuration command comprises using a command that indicates a target device, an operation to be performed on the target device, and a parameter to be used to perform said operation.

23. The method of claim 21, wherein receiving the signal from the I/O device comprises using an I/O device including a display and a directional keypad.

24. A storage unit, comprising:
a plurality of storage devices; and
means for enabling a user to configure the plurality of storage devices by interacting directly with the storage unit;
wherein the means for enabling is used exclusively with the storage unit.

25. The storage unit of claim 24, wherein the plurality of storage devices are configured in accordance with a configuration command assembled using said means for enabling.

26. A storage medium containing code which, when executed by a processor, causes the processor to:
receive a signal from an input/output (“I/O”) device directly connected to the storage unit, said signal indicative of a configuration command assembled using the I/O device for implementation in said storage unit; and
configure said storage unit in accordance with said configuration command.

27. The storage medium of claim 26, wherein said configuration command indicates a target device and an action to be performed on said target device.

28. The storage medium of claim 27, wherein said configuration command further indicates a parameter associated with said action.
